(19) United States
(12) Patent Application Publication
(10) Pub. No.: US 2012/0162859 A1
(43) Pub. Date: Jun. 28, 2012

(54) ELECTROLYTIC CAPACITOR AND METHOD FOR MANUFACTURING THE SAME

(76) Inventor: Hideo Yokoo, Fukaya-shi (JP)

(21) Appl. No.: 13/247,602

(22) Filed: Sep. 28, 2011

(30) Foreign Application Priority Data
Dec. 24, 2010 (JP) 2010-288824

(51) Int. Cl. H01G 9/04; H01G 9/00

(52) U.S. Cl. 361/503; 29/25.03

(57) ABSTRACT

According to one embodiment, an electrolytic capacitor includes a first electrode foil, a second electrode foil and an insulating member. The first electrode foil is formed like a loop and configured in such a manner that a first terminal is connected to a predetermined position. The second electrode foil is formed like a loop in such a manner that an outer periphery of the second electrode foil lies opposite an inner periphery of the first electrode foil. An insulating member is formed like a loop interposed between the inner periphery of the first electrode foil and the outer periphery of the second electrode foil.

### CROSS-REFERENCE TO RELATED APPLICATIONS

This application is based upon and claims the benefit of priority from Japanese Patent Application No. 2010-288824, filed Dec. 24, 2010; the entire contents of which are incorporated herein by reference.

### FIELD

Embodiments described herein relate generally to an electrolytic capacitor and a method for manufacturing the electrolytic capacitor.

### BACKGROUND

As is well known, an electrolytic capacitor is constructed by forming an integral foil by sandwiching insulating paper soaked with an electrolytic solution between an anode foil and a cathode foil, and rolling the integral foil from one end thereof. Thus, the electrolytic capacitor contains a resistive component and an inductive component in addition to an inherent capacitive component.

Hence, the electrolytic capacitor tends to have a high internal impedance and thus a heavy power loss. Thus, for example, passage of a ripple current through the electrolytic capacitor causes the electrolytic capacitor to be internally heated. The heat raises the temperature of the electrolytic capacitor, thus significantly affecting the life of the electrolytic capacitor. Therefore, at present, there is no other choice but to set an allowable ripple current to be small.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram showing an example of a main component forming an electrolytic capacitor main body according to an embodiment;

FIG. 2 is a diagram illustrating an example of a method for manufacturing an electrolytic capacitor main body according to the embodiment;

FIG. 3 is a diagram showing an example of a main structure of the electrolytic capacitor main body according to the embodiment;

FIG. 4 is a diagram showing an example of a main component of an electrolytic capacitor according to a conventional art;

FIG. 5 is a diagram showing an example of a main method for manufacturing an electrolytic capacitor according to the conventional art;

FIG. 6 is a circuit diagram illustrating an example of an equivalent circuit of the electrolytic capacitor according to the conventional art;

FIG. 7 is a circuit diagram illustrating an example of an equivalent circuit of the electrolytic capacitor main body according to the embodiment;

FIG. 8 is a diagram illustrating an example of a method for rolling an electrolytic capacitor main body according to the embodiment;

FIG. 9 is a perspective view illustrating an example of the shape of the electrolytic capacitor main body according to the embodiment; and

FIG. 10 is a perspective view illustrating an example of the shape of the electrolytic capacitor according to the embodiment.

### DETAILED DESCRIPTION

Various embodiments will be described hereinafter with reference to the accompanying drawings. In general, according to one embodiment, an electrolytic capacitor comprises a first electrode foil, a second electrode foil and an insulating member. The first electrode foil is formed like a loop and configured in such a manner that a first terminal is connected to a predetermined position. The second electrode foil is formed like a loop in such a manner that an outer periphery of the second electrode foil lies opposite an inner periphery of the first electrode foil. An insulating member is formed like a loop interposed between the inner periphery of the first electrode foil and the outer periphery of the second electrode foil.

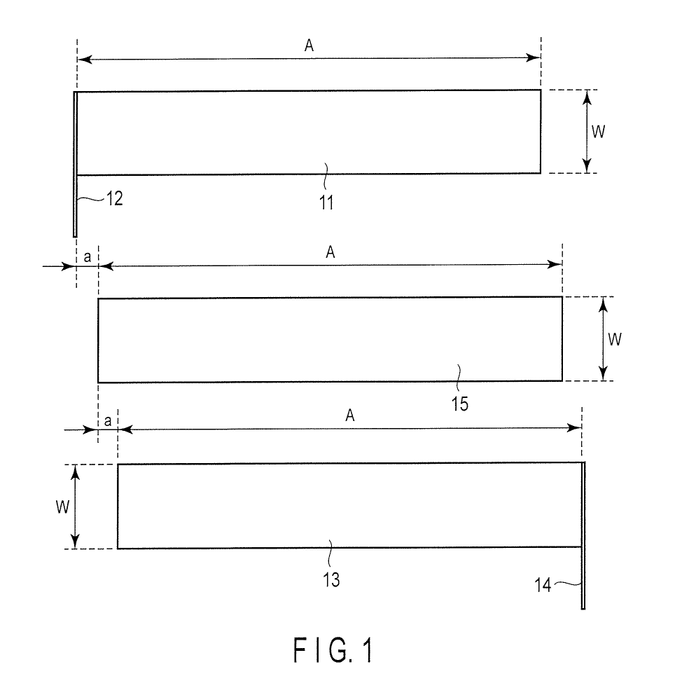

That is, in FIG. 1, reference number 11 denotes an anode foil corresponding to one of the electrode foils. The anode foil 11 is formed of a conductive material, for example, aluminum and shaped like a band of predetermined width W and predetermined length A. An anode terminal 12 shaped substantially like a bar is connected to one end of the anode foil 11.

Furthermore, in FIG. 1, reference number 13 denotes a cathode foil corresponding to the other electrode foil. Like the anode foil 11, the cathode foil 13 is formed of a conductive material, for example, aluminum and shaped like a band of predetermined width W and predetermined length A. A cathode terminal 14 shaped substantially like a bar is connected to one end of the cathode foil 13.

Moreover, in FIG. 1, reference number 15 denotes insulating paper corresponding to an insulating member. The insulating paper 15 is immersed in an electrolytic solution and shaped like a band of predetermined width W and predetermined length A like the anode foil 11 and the cathode foil 13.

The anode foil 11, the cathode foil 13, and the insulating paper 15 are laid on top of one another so that the insulating paper 15 is sandwiched between the anode foil 11 and the cathode foil 13. In this case, the anode foil 11, the cathode foil 13, and the insulating paper 15 are arranged as follows: the insulating paper 15 is displaced from the anode foil 11 by a predetermined distance (a) in a longitudinal direction thereof, and the cathode film 13 is displaced from the insulating paper 15 by the same predetermined distance (a) in a longitudinal direction thereof.

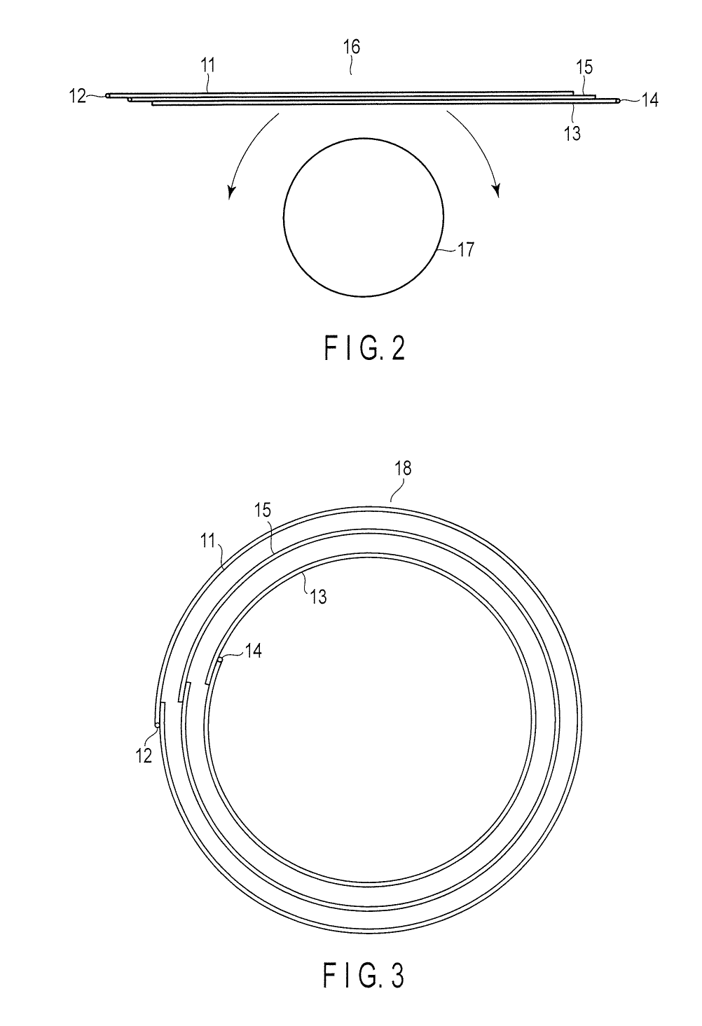

Thus, such an integral foil 16 as shown in FIG. 2 is formed. In each of the anode foil 11, cathode foil 13, and insulating paper 15 in the integral foil 16 thus formed, one and the other surfaces at the respective opposite ends are exposed.

The integral foil 16 is then wound around a cylindrical roller 17 of circumference slightly less than the length A of each of the anode foil 11, the cathode foil 13, and the insulating paper 15. Then, as shown in FIG. 3, in each of the anode foil 11, the cathode foil 13, and the insulating paper 15, the one and other surfaces at the respective opposite ends are brought into contact with each other. Thus, an electrolytic capacitor main body 18 is formed.

That is, in the electrolytic capacitor main body 18, each of the anode foil 11, the cathode foil 13, and the insulating paper 15 is shaped like an endless loop. An outer periphery of the cathode foil 13 is arranged opposite an inner periphery of the anode foil 12. The insulating paper 15 is interposed between the inner periphery of the anode foil 12 and the outer periphery of the cathode foil 13.

In FIG. 3, the anode foil 11, the cathode foil 13, and the insulating paper 15 are shown to be separate from one another so as to indicate, in an easily understandable manner, that the opposite ends of each of the anode foil 11, the cathode foil 13, and the insulating paper 15 contact each other. However, in actuality, the anode foil 11 and the insulating paper 15 contact each other with no gap between the anode foil 11 and the insulating paper 15. The insulating paper 15 and the cathode foil 13 contact each other with no gap between the insulating paper 15 and the cathode foil 13.

Furthermore, each of the anode foil 11 and the cathode foil 13 has only to be such that the opposite ends thereof contact each other for electrical continuity. However, the opposite ends can be bonded together with a conductive adhesive or welded together. Also for the insulating paper 15, the opposite ends have only to contact each other but may be fastened together.

In the electrolytic capacitor main body 18, the anode foil 11 is shaped like a loop having no end as seen from the anode terminal 12. Thus, the distance between the anode terminal 12 and a position on the anode foil 11 that is furthest from the anode terminal 12 is half the original length A of the anode foil 11. That is, the distance is A/2. Namely, two paths of the same length (A/2) lie parallel between the anode terminal 12 and the position on the anode foil 11 that is furthest from the anode terminal 12.

Furthermore, the cathode foil 13 is also shaped like a loop having no end as seen from the cathode terminal 14. Thus, the distance between the cathode terminal 14 and a position on the cathode foil 13 that is furthest from the cathode terminal 14 is half the original length A of the cathode foil 13. That is, the distance is A/2. Namely, two paths of the same length (A/2) lie parallel between the cathode terminal 14 and the position on the cathode foil 13 that is furthest from the cathode terminal 14.

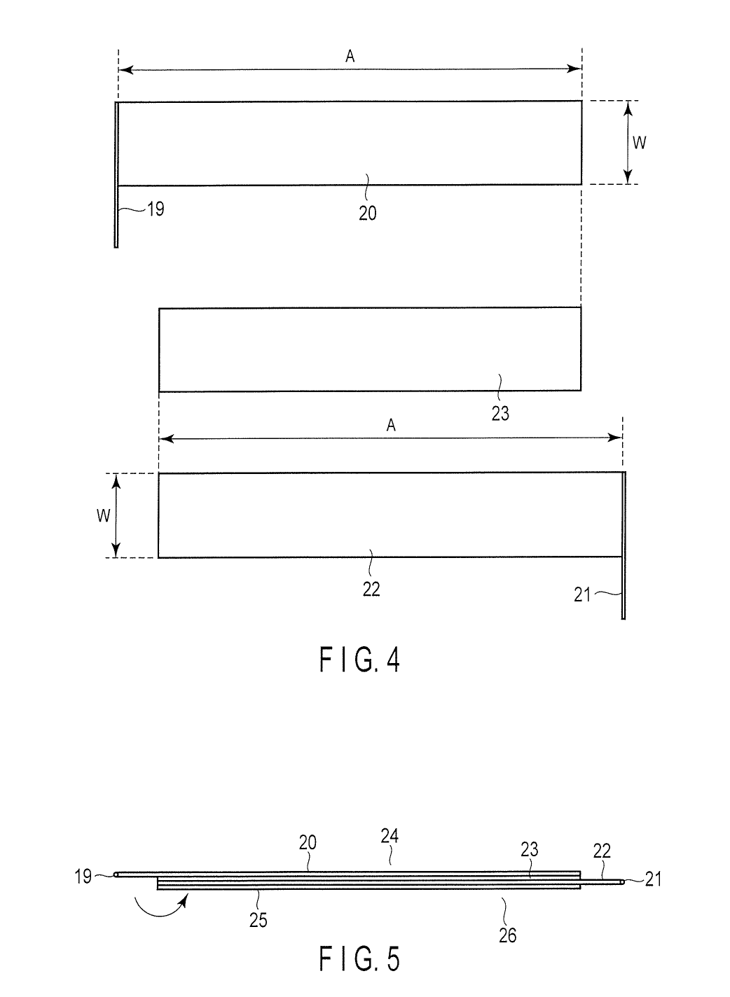

In the conventional art, as shown in FIG. 4, an integral foil 24 is formed by laying a band-shaped anode foil 20, a band-shaped cathode foil 22, and insulating paper 23 on top of one another so that the insulating paper 23 is sandwiched between the anode foil 20 and the cathode foil 22 as shown in FIG. 5; the anode foil 20 is of width W and length A and includes an anode terminal 19 connected to one end thereof, the cathode foil 22 is of width W and length A and includes a cathode terminal 21 connected to one end thereof, and the insulating paper 23 is immersed in an electrolytic solution. Then, another insulating paper 25 is added to the integral foil 24. The resultant integral foil is rolled from one end thereof as shown by an arrow in FIG. 5. Thus, an electrolytic capacitor main body 26 is formed.

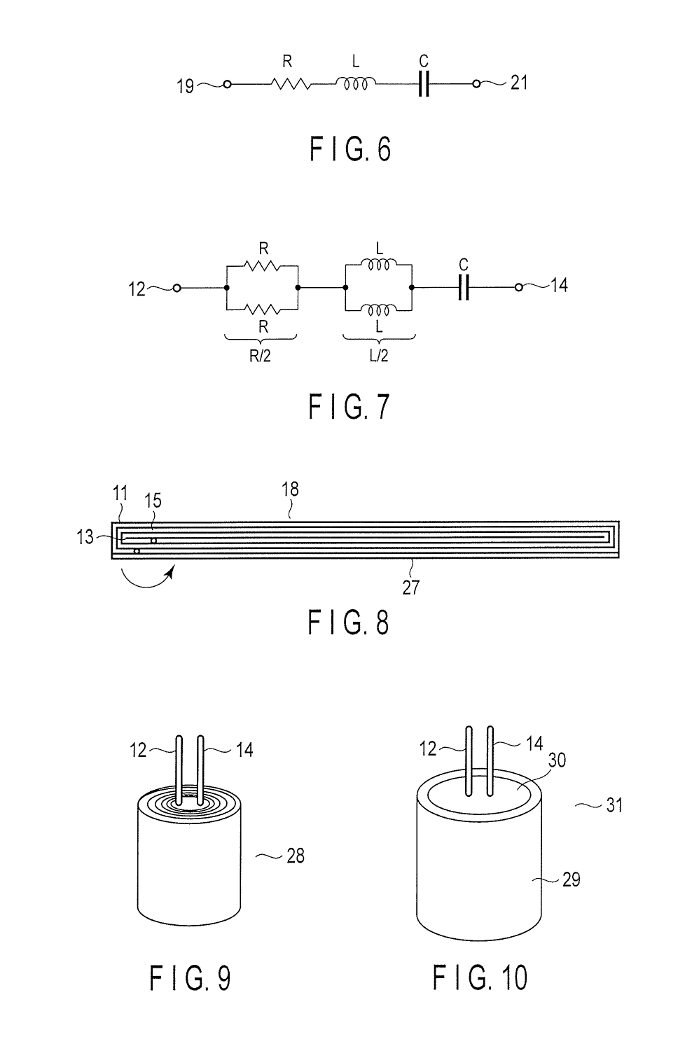

FIG. 6 shows an equivalent circuit of the electrolytic capacitor main body 26 according to the conventional art. As is well known, the equivalent circuit is expressed as a resistive component R, an inductive component L, and a capacitive component C connected in series between the anode terminal 19 and the cathode terminal 21. The internal impedance Z1 between the anode terminal 19 and cathode terminal 21 of the electrolytic capacitor main body 26 according to the conventional art is expressed by:

$$Z 1 = \sqrt{{R}^{2} + {( ω L - \frac{1}{ω C} )}^{2}} \\ ω = 2 π f \qquad ( 1 )$$

π: circumference constant, f: frequency

In this case, the resistive component R is determined mainly by the anode terminal 19 and the cathode terminal 21 as well as the distance A between each of the anode terminal 19 and the cathode terminal 21 and a point on a corresponding one of the anode foil 20 and the cathode foil 22 which point is furthest from the anode terminal 19 or the cathode terminal 21. Moreover, the capacitive component C is determined by the overlapping area between the anode foil 20 and the cathode foil 22.

In contrast, an equivalent circuit of the electrolytic capacitor main body 18 shown in FIG. 3 is as shown in FIG. 7. That is, as described above, two paths each of a length (A/2) half the original length A of the anode foil 11 lie parallel between the anode terminal 12 and the point on the anode foil 11 which point is furthest from the anode terminal 11. Furthermore, two paths each of a length (A/2) half the original length A of the cathode foil 13 lie parallel between the cathode terminal 14 and the point on the cathode foil 13 which point is furthest from the cathode terminal 14.

Thus, as the resistive component, resistances each of resistance R are connected together in parallel. Theoretically, the resistive component of the equivalent circuit decreases to R/2.

This also applies to the inductive component. Inductances each of inductance L are connected together in parallel. Thus, theoretically, the inductive component of the equivalent circuit decreases to L/2.

For the capacitive component C, since the overlapping area between the anode foil 11 and the cathode foil 12 is the same as that in the electrolytic capacitor main body 26 according to the conventional art, the same capacitive component C is held.

That is, the internal impedance Z2 between the anode terminal 12 and cathode terminal 14 of the electrolytic capacitor main body 18 shown in FIG. 3 is theoretically expressed by:

$$Z 2 = \sqrt{{( \frac{R}{2} )}^{2} + {( \frac{ω L}{2} - \frac{1}{ω C} )}^{2}} \qquad ( 2 )$$

As is apparent from Expression (2), the electrolytic capacitor main body 18 shown in FIG. 3 has both resistive component and inductive component reduced to half compared to the electrolytic capacitor main body 26 according to the conventional art. Thus, the internal impedance can be reduced without changing the capacitive component C. This enables a significant reduction in power loss, allowing the allowable ripple current to be set greater than in the case of the conventional art.

Furthermore, the electrolytic capacitor main body 18 shown in FIG. 3 is convenient in a practical sense because the position of the cathode terminal 14 with respect to the anode terminal 12 can be easily changed by varying the amount by which the cathode foil 13 is displaced from the anode foil 11 in the longitudinal direction.

Moreover, the electrolytic capacitor main body 18 shown in FIG. 3 is configured such that each of the substantially bar-shaped anode terminal 12 and cathode terminal 14 is connected to one end of the corresponding one of the anode foil 11 and cathode foil 13 formed substantially like a band. Thus, the connection technique according to the conventional art can be used without any change. This facilitates the operation of connecting the anode terminal 12 and the cathode terminal 14 to the anode foil 11 and the cathode foil 13, respectively.

The electrolytic capacitor main body 18 is excessively large in size if put to practical use without any change. The electrolytic capacitor main body 18 is thus unsuitable for practical use in which the electrolytic capacitor main body 18 is mounted on a circuit board. Hence, as shown in FIG. 8, such a small-sized electrolytic capacitor main body 18 as shown in FIG. 9 is constructed by collapsing the electrolytic capacitor main body 18 into a flat shape by means of pressing, adding another insulating paper 27 to the pressed electrolytic capacitor main body 18, and rolling the resultant electrolytic capacitor main body 18 from one end as shown by an arrow in FIG. 8.

Then, a electrolytic capacitor 31 of practical size is constructed by housing the electrolytic capacitor main body 28 in a case 29 and blocking an opening of the case 29 with a sealant 30 so as to expose the anode terminal 12 and the cathode terminal 14 to the exterior as shown in FIG. 10.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electrolytic capacitor comprising:
a first electrode foil formed like a loop and configured in such a manner that a first terminal of the first electrode foil is connected to a predetermined position;
a second electrode foil formed like a loop in such a manner that an outer periphery of the second electrode foil lies opposite an inner periphery of the first electrode foil, the second electrode foil being further configured in such a manner a second terminal of the second electrode foil is connected to a predetermined position; and
an insulating member formed like a loop interposed between the inner periphery of the first electrode foil and the outer periphery of the second electrode foil.

2. The electrolytic capacitor of claim 1, wherein the first electrode foil is a metal foil formed substantially like a band and including the first terminal connected at one end, and is configured in such a manner that opposite ends of the first electrode foil contact each other,
the second electrode foil is a metal foil formed substantially like a band and including the second terminal connected at one end thereof, and is configured in such a manner that opposite ends of the second electrode foil contact each other, and
the insulating member is paper formed substantially like a band and soaked with an electrolytic solution, and is configured in such a manner that opposite ends of the insulating member contact each other.

3. The electrolytic capacitor of claim 1, further comprising:
a case configured in such a manner that a structure obtained by flattening a loop formed by sandwiching the insulating member between the first electrode foil and the second electrode foil and rolling the flattened loop from one end is housed in the case; and
a sealant configured to occlude an opening in the case with the first and second terminals exposed.

4. A method for manufacturing an electrolytic capacitor, the method comprising:
forming an integral foil by sandwiching an insulating material formed substantially like a band between a first electrode foil formed substantially like a band and including a first terminal connected to one end thereof and a second electrode foil formed substantially like a band and including a second terminal connected to one end thereof, displacing the insulating member from the first electrode foil by a predetermined distance in a longitudinal direction of the insulating member, and displacing the second electrode foil from the insulating member by a predetermined distance in a longitudinal direction of the second electrode foil; and
rolling the integral foil into a loop in such a manner that opposite ends of the first electrode foil contact each other, that opposite ends of the insulating member contact each other, and that opposite ends of the second electrode foil contact each other.

5. The method for manufacturing an electrolytic capacitor of claim 4, further comprising:
collapsing and flattening the integral foil rolled into the loop, rolling the collapsed integral foil from one end thereof, and housing the rolled integral foil in a case; and
blocking an opening in the case with a sealant with the first and second terminal exposed.
